(19) United States
(12) Patent Application Publication
(10) Pub. No.: US 2007/0127164 A1
(43) Pub. Date: Jun. 7, 2007

(54) Nanoscale Sensor

(75) Inventors: Eran Ofek, Modi'in (IL); Amir Lichtenstein, Tel Aviv (IL); Noel Axelrod, Jerusalem (IL)

Correspondence Address: EDWARD S. SHERMAN, ESQ., 3554 ROUND BARN BLVD., SUITE 303, SANTA ROSA, CA, 95403, US

(73) Assignee: Physical Logic AG, Zug (CH)

(21) Appl. No.: 11/560,826

(22) Filed: Nov. 16, 2006

Related U.S. Application Data
(60) Provisional application No. 60/738,793, filed on Nov. 21, 2005.
(60) Provisional application No. 60/738,778, filed on Nov. 21, 2005.
(60) Provisional application No. 60/738,927, filed on Nov. 21, 2005.

(51) Int. Cl. G11B 5/33; G11B 5/127

(52) U.S. Cl. 360/324

(57) ABSTRACT

A plurality of densely packed nano-particles are arrayed on a elastic substrate via an intervening spacer by a combination of self-assembly methods or imprinting. The coated substrate is useful as a sensor device as the substrate is sufficiently non-rigid such that the deformation increases the separation between nano-particles resulting in a measurable change in the physical properties of the array. When the array comprises of closely packed conductive nano-particles deformation of the substrate disturbs the electrical continuity between the particles resulting in a significant increase in resistivity. The various optical properties of the device may exhibit measurable changes depending on the size and composition of the nano-particles, as well as the means for attaching them to the substrate.

### CROSS REFERENCE TO RELATED APPLICATIONS

The present application claims priority to the U.S. provisional application having Ser. No. 60/738,927 entitled “Nanoparticle Vibration and Acceleration Sensors”, filed on Nov. 21, 2006 which is incorporated herein by reference. The present application also claims priority to the U.S. provisional application having Ser. No. 60/738,793 entitled “Nanoscale Sensor”, filed on Nov. 21, 2006 which is incorporated herein by reference. The present application further claims priority to the U.S. provisional application having Ser. No. 60/738,778 entitled “Polymer Nanosensor Device”, filed on Nov. 21, 2006 which is incorporated herein by reference.

### BACKGROUND OF INVENTION

The present invention relates to a composition of useful structures and configures therefore for forming sensors having an ultra-high sensitivity to acceleration, deformation, vibration and the like physical disturbances.

Prior methods of sensing small mechanical movements, vibration or acceleration generally deploy micro-electrical mechanical systems (MEMS) type devices. Such devices can be fabricated in part on silicon wafers extending technology developed for semiconductor microelectronic processing. The current generation of such sensors needs power, which increases their size and limits the life span. There is a continuing effort to increase the sensitivity of such devices, reduce their size and power consumption to expand their deployment to a wide range of engineering, industrial, aerospace and medical applications. It is particularly desirable to achieve a level of sensor miniaturization to be able to implant such sensor devices into structures or operating equipment without disturbing operation or taking space.

Ideally, it would be desirable to have sensors that can detect motion on a molecular scale, without interfering with molecular scale processes. For example, many biological processes occur on a cellular level and are inherently nanoscale. The failure of structures and engineering materials initiates as a nanoscale process.

### SUMMARY OF INVENTION

In order to detect the smallest movements or vibrations it would be desirable to have a sensor having a functional element that is nano sized, yet wherein the changes in the sensor properties would be readily measurable on a macroscopic level for high reliability and facile integration with electronics and instruments. For example, it would be desirable that the state of the sensor device could be read continuously by very low power electrical or optical measurements.

Such a nano sized sensor could conceivable be integrated with other items of manufacture or used in the human body yet without interfering with function. Indeed a nanoscale sensor element would have to be able to respond to affine deformations on a nanoscale to enable nanoscale devices.

Ideally, a nanoscale sensor element that can be deposited by thin film deposition methods generally compatible with semiconductor type processing steps used to manufacture MEMS and nanoscale devices.

The above an other advantages and objects have been accomplished by the invention of a nano-sensor comprising a non-rigid substrate, a columnar spacer disposed on said non-rigid substrate, an array of particles bonded to said substrate via said spacer wherein at least one column is connected to each particle, whereby deformation of said non-rigid substrates results in a perturbation to the distribution of the nano-particles in said array to produce a measurable change in the aggregate physical property of said array.

In still other and preferred embodiments of the invention, the columnar spacer is a molecular species bond to the substrate and the particles are nanospheres. The use of conductive nanospheres allows a relatively small perturbation to the array to be measured by electrical continuity across the device. In other embodiments, the particles are nanocrystals or quantum dots whose optical properties depend on the state of coalescence or aggregation.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-section view schematically illustrating the nano and molecular structure of the sensor (FIG. 1a) and the operative principles thereof (in FIG. 1b)

FIG. 2A is a theoretical (calculated from a FEM model) plot of resistance of a nanoparticle array as a function of distance between particle for nanoparticle materials of different work functions.

FIG. 2B is a theoretical (calculated from a FEM model) plot of resistance versus nanoparticle displacement.

FIG. 3 is a cross-section view schematically illustrating an alternative nano and molecular structure of the sensor in which multiple molecules form the spacer component

FIG. 4 is a cross-section view schematically illustrating an alternative nano and molecular structure of the sensor wherein the spacer component is a nanotube.

FIG. 5 is a cross-section view schematically illustrating an alternative nano and molecular structure of the sensor wherein the spacer component comprises a mesogenic species capable of forming a liquid crystal structure

FIG. 6 is a cross-section view schematically illustrating an alternative nano and molecular structure of the sensor wherein the spacer component comprises a protein, nucleic acid or other structure of biological origin

FIG. 7 is a cross-sectional view schematically illustrating alternative steps in forming the structures shown in FIG. 1A and FIG. 4 respectively.

FIG. 8 is a cross-section view schematically illustrating the device of FIG. 1 deployed with additional components as a sensor (electrical)

FIG. 9 is a cross-section view schematically illustrating the device of FIG. 1 deployed with additional components as a sensor (optical)

FIG. 10 is a cross-section view of an alternative nano and molecular structure for use as an optical sensor.

FIGS. 11A and 11B illustrate the initial steps in an alternative embodiment of a method of forming the nanoarray.

FIGS. 12A and 12B illustrate sequential steps to those shown in FIG. 11.

FIGS. 13A and 13B illustrate sequential steps to those shown in FIG. 12.

FIGS. 14A and 14B illustrate sequential steps to those shown in FIG. 13.

FIGS. 15A and 15B illustrate sequential steps to those shown in FIG. 14.

### DETAILED DESCRIPTION

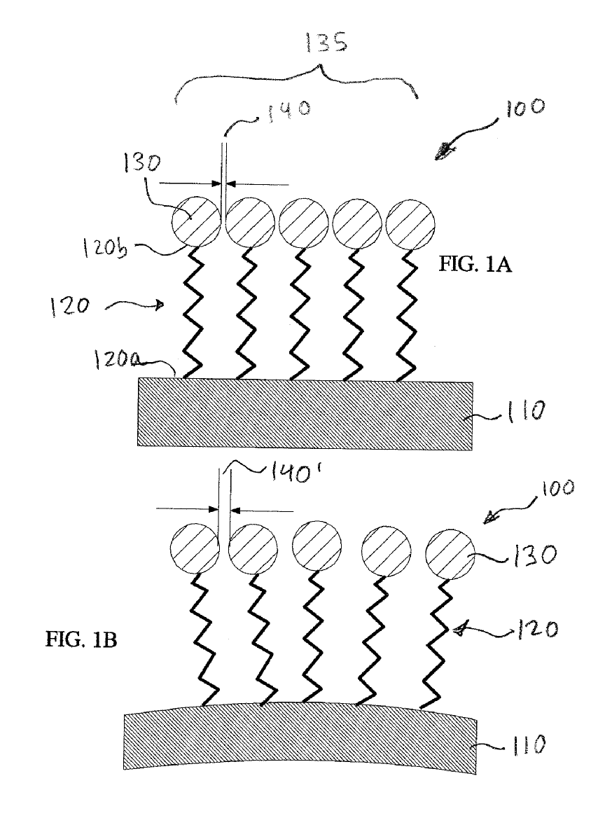

Referring to FIGS. 1 through 15, wherein like reference numerals refer to like components in the various views, there is illustrated therein a new and improved sensor, generally denominated 100 herein.

In accordance with the present invention, a nanoscale device is constructed on a non-rigid substrate 110. As shown in FIG. 1A, various long chain molecules 120 or high aspect ratio molecular assemblies are attached at one end 120a to the non-rigid substrate to extend upward from the substrate to form a dielectric or non electrically conductive column. On the other end of the column 120b is attached substantially equiaxed particles 130. The column distribution on the substrate is adjusted relative to the dimensions of the substrate to form a densely packed array of particle 135 such that the columns 120 act as spacers separating the particle 130 in the array 135 away from the substrate. Depending on the spacing and size of the molecular species that forms columns 120 and the size of the particles 130, a gap 140 may exist between particles 130 in array 135. The gap is preferably between about 0 to 2 nm, and more preferably 0 to 0.2 nm such that there will be electrical continuity across array 135. It is believed that a gap of several nanometers between particles will still lead to electrical continuity because electrons can quantum mechanically tunnel across such a narrow gap.

FIG. 1B illustrates one operative principle of device 100 when non-rigid substrate 110 is slightly deformed, that is bent in the plane perpendicular to the drawing. The bending of substrate 110 is believed to cause a splay between columns 120 due to the change in curvature of the surface of substrate 110. This splay then increases the separation between the columns at the upper end 120b, where they are attached to particle 130, such that the gap 140′ is now increased from that shown in FIG. 1A as 140. The increase in particle separation thus results in an increase in the electrical resistance, i.e. a decrease in electrical conductivity. As a very small increase in the gap 140 between particles will result in a large increase in resistance, the ideal ordered array 135 provides a highly sensitive means to detect deformation of substrate 110.

It should also be apparent, that the structure illustrated in FIG. 1. can also measure the change in temperature of the environment as a result of the thermal expansion effect of the substrate. Where the temperature rises, the substrate will expand and therefore the distance between the columns 120 will changes and therefore the distance between particles 130 will also change causing a measurable change in the electrical conductivity of the array 135. It should also be appreciated that when the temperature will decrease, the substrate will contract back and the effect will be reversed.

It should also be appreciated that in case that substrate 110 is comprised of two different materials that have different thermal expansion coefficients, the sensitivity of device 100 to temperature changes will be increased as a result of the fact that the changes in the expansion of both substrate will cause a larger deformation and therefore will cause a greater change in the electrical resistance of device 100.

The preferred embodiments deploys particles that are preferably nano-scale, spherical and mono-disperse in size. More specifically the size of such nano-scale particle is preferably 1 to 100 nanometers. Further, the particles are preferably conductive, and may include Au, Ag, Pt, Pd, boron or phosphorus doped nickel (Ni(B) or Ni(Ph)), indium tin oxide (ITO), SnO2, and the like, as well as mixtures thereof. It being more preferable that the particles are of noble metals not subject to oxidation that would increase the inter-particle resistivity, i.e. Au, Pt or Pd.

In one embodiment, gold nanoparticles can be made by first dissolving 10 mg HAuCl₄ in 98 ml deionized water. While this solution is vigorously refluxing, with stirring or other agitation, 2 ml of a solution of 100 mg of trisodium citrate solution in 10 ml deionized water is rapidly injected to disperse uniformly. Continuing the reflux and stirring for about 1 hour will produce a clear liquid with a red color. Thereafter, heating is stopped while stirring continues until the red liquid reaches room temperature.

In light of the foregoing, one of ordinary skill in the art will appreciate that alternative nano scale particles include non-conductive particles having a metallic or otherwise stable conductive coating, such as phosphorus or boron-doped nickel that might be deposited by electro-less deposition from solution. As the molecular species that form column 120 are selected to be relatively rigid, in at least one dimension, to transmit movement of the substrate to the particles, they also appear to sterically self-limit the density of attachment to the substrate, and hence the ultimate spacing of particle 130 to a greater uniformity.

It should be appreciated that the particle arrays of the instant invention can be distinguished from prior art sensors or devices that measure changes of resistivity of dispersed conductive particles. Such dispersions are not controlled, that is they are random and hence depend on the density of particles reaching a percolation threshold to function. However, when the percolation threshold is reached their will also be a random separation distance between particles through the material.

However, scale, size and structure of the arrays of the instant invention offer unique advantages over this prior art. First, it should be appreciated that because the spacing between particles can be controlled by the molecular structure of the species forming the column, the device sensitivity can be extremely high (that is detect nanoscale deformation) with a very high dynamic range.

The electrical properties of the intended nanoparticle array can be modeled as a square lattice of spherical metallic) (preferably gold but with other materials being possible) nanoparticles of radius r where the mean distance between the particles is d. We assume further that the position of each nanoparticle is random and described by the Gaussian distribution with standard deviation σ the optimum. The first row and the last row of nanoparticles are placed on electrodes that are connected to the DC voltage source. The tunneling probability p between two neighboring particles is given by the expression:
ρ=A exp(−2βd) (1)
where d is the distance between the particles, β is the tunneling coefficient and A is normalization coefficient. The parameter β depends on the work function of the metal W_{ƒ} and on the energy of the electron E as

$$β = \sqrt{\frac{2 {m}_{e} ( {W}_{f} - E )}{{ℏ}^{2}}} \qquad ( 2 )$$

where mₑ is the electron mass and E is given by the expression
E=Eₙ+eE·d (3)
where the first term in the Eq. (3) represents the energy on the n^{th} level of the electron in the particle and the second term is contribution to the energy due to electric potential between the electrodes. E in Eq. (3) is the electric field between the nanoparticles. The probability to find an electron on the level Eₙ is given by Fermi distribution.

For typical values of the work functions of metals in the range 4 to 5 eV, the value of β is about 1 Å⁻¹. The total resistance between the electrodes can be calculated by treating the system as a network of resistors. Each resistance in this network represents the tunneling resistance between two nanoparticles. Since the tunneling resistance is inversely proportional to the tunneling rate, it could be written from Eq. 1 as following
R_{p,q}=R₀ exp(2β_{p,q}d_{p,q}) (4)
where the indexes p, q refer to the two adjacent particles and R₀ is the contact resistance between two nanoparticles.

The total resistance R of the entire circuit will depend on a number of parameters, such as the mean distance between the nanoparticles d, the standard deviation in position of the nanoparticles σ, which is a parameter of the lattice disorder, on the size of the lattice M×N, on the working function W_{ƒ} of the nanoparticle material, on the temperature T and on the voltage V between the electrodes, etc. If we consider a system of nanoparticles as a piezoresistive device, that is the resistance of the device changes due to applied stress, then we should take into account that there is an upper limit of resistance of the sensing element. This limit can be determined by a number of physical reasons such as the minimum detectable current or thermal noise on the resistance.

The thermal noise power for a detection system of a bandwidth B is P_{n,th}=4k_{B}TB. Where k_{B} is the Boltzman constant, T is temperature. The thermal noise can be treated as the voltage noise through the relation P_{n,th}= V̅_̅{̅n̅,̅t̅h̅}̅²̅/R. Where V_{n,th} is the thermal voltage.

For example, the resistance R=10¹¹Ω gives the thermal voltage noise of 40 μV/√Hz or about 1.3 mV in a bandwidth of 1 KHz. In addition, for R=10¹¹Ω the current between the electrodes is only 1 nA for a 10 V bias. That current is comparable with the leakage currents in semi-conductive materials. If we restrict ourselves by the maximum resistance 10¹¹Ω, then we could conclude that the maximum distance d between the nanoparticles should be less than 1 nm and uncertainty in the position of nanoparticles in the lattice smaller than 0.5 nm.

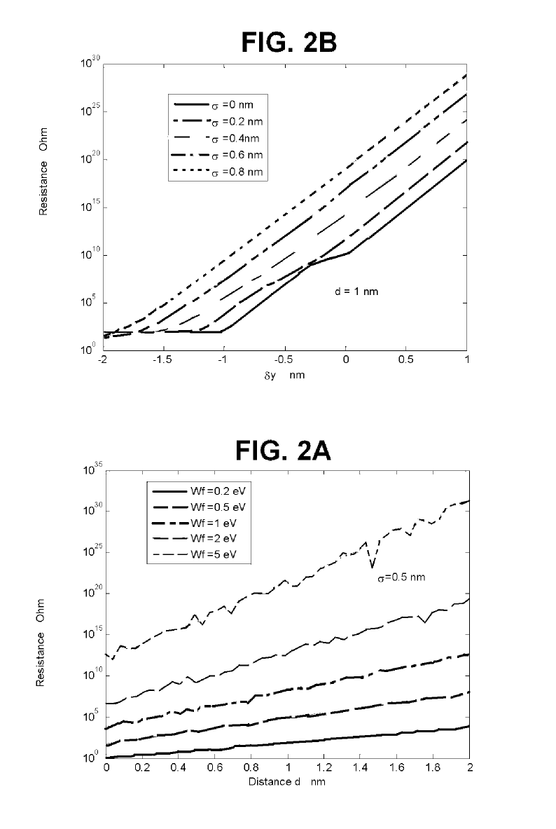

The resistance of the nanoparticle array depends not only on d and σ but also on the material from which the nanoparticles are made of, or more precisely on the working function of that material. The dependence of R on the distance between the nanoparticles and on the working function of the material is shown on FIG. 2A. It is seen from the figure that R increases quickly with W_{ƒ}. It also follows from the figure that the distance d between the nanoparticles could be increased as W_{ƒ} decreases in order for R not to exceed the upper limit. For example, at a distance d=2 nm and W_{ƒ}=1 eV the resistance R is 10¹¹Ω.

An alternative way for reducing the working function is to use a thin layer of organic material attached to the metal nanoparticles as taught by V. De Renzi et al. in Phys. Rev. Lett. 95, 046804 (2005) “Metal Work-Function Changes Induced by Organic Adsorbates: A Combined Experimental and Theoretical Study”, which is incorporate herein by reference. This work shows that the gold work-function changes by about −1.6 eV by using organic adsorbents (CH₃S)₂. It is further preferred to use bisthiolated alkane to connect adjacent metallic nanoparticles.

FIG. 2B is a theoretical (calculated from a FEM model) plot of resistance versus nanoparticle displacement δy by assuming an initial mean distance between the nanoparticles d of 1 nm. Negative values of δy correspond to the compression while positive values of δy correspond to the expansion of the structure. We can see from the figure that R exponentially increases with δy nearly in all ranges of displacement except large negative displacements (smaller −1 nm) when it approaches a constant value. The dependence of R on δy is really dramatic. Changing δy by about 1 nm changes R in about 10¹⁰ times!

Hence, by selection of the device dimension through the construction with uniform precursors, i.e. the columns 120 and the particle 130, a device can be constructed wherein the slightest perturbation to the dense array of particles will initiate a large change in resistance. Further, since the array is spatially uniform it can be decreased in size to the minimum number of particles necessary to make ohmic contact with external junctions.

However, a dispersed particle array cannot be subdivided to such an extent because as the scale of division approaches the percolation scale there will be massive variations in the particle density and spacing, hence giving wide fluctuations in the base resistance and the dynamic range of each such portion. For the same reasons local deformations of such prior art materials smaller that the percolation scale cannot be reliably measured.

In contrast, the sensor device of the instant invention can be reduced on a lateral scale commensurate with the event or object to be measured, as local deformation of the substrate will produce the same response regardless of the lateral position in the area. Finally, as the nano-sensor has molecular dimensions it can be expected to be responsive to and detect molecular motion on a comparable scale that is just above phonon vibrations. Further, the homogenous nature of the conductive particle array ensures ohmic contact with external electrodes, which can be problematic when conductive particles are dispersed in an insulating matrix, as the matrix can form an outer layer of the device.

It should also be understood that the description of the substrate as non-rigid is only to the extent that the combination of modulus of elasticity and thickness do not inhibit either of the responses described with respect to FIG. 1 and FIG. 2. For example, a mineral or inorganic substrate like mica would have sufficient flexibility at a thickness of even 1-2 microns to function as a non-rigid substrate. It has also been found that PDMS with a thickness of 100 to 150 microns will be suitable as a substrate. Accordingly, depending on the substrate thickness alternative substrates include without limitation inorganic materials such as mica (nominally K2O.Al2O3.SiO2), silicon, silicon dioxide, glass and organic materials, or alternative organic polymers such as polydimethylsiloxane (PDMS), Polymethylmethacrylate (PMMA), polymers of Hydroxy ethyl methacrylate (HEMA) monomer, cellulose, azlactone polymers, polystyrene, and the like. It should also be appreciated that the term substrate may also encompass the underlying article or device to be measured. In such instances, an initial substrate used in fabrication might be sacrificial or removed in the process.

Polymers with azlactone functional groups are desired because an azlactone group at the surface will readily react with available primary amines to produce a highly stable covalent bond. Such polymers include poly(2-vinyl-4,4-dimethylazlactone-co-acrylamide-co-ethylene dimethacrylate), which is known for the ability to bond proteins such as the enzyme trypsin.

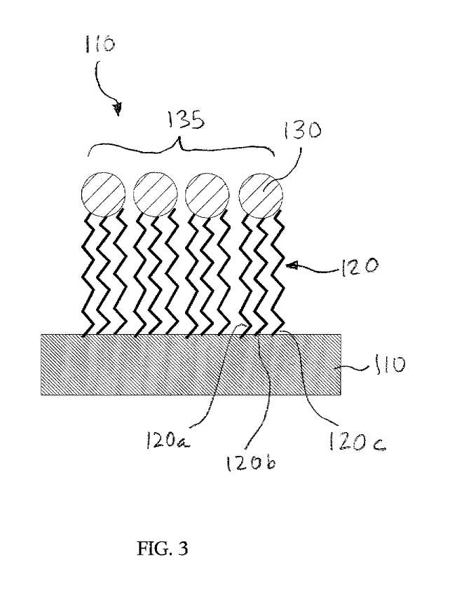

It will be further appreciated by one of ordinary skill in the art that the options of favoring one of the alternative mechanisms of FIG. 1 and FIG. 2 depends on the relative rigidity and elastic properties of the molecular species used to form the columnar spacer 120. FIG. 3 through 7 illustrates a non-limiting range of alternative spacer molecular species.

It should be appreciated that one nano-particle may be bound to one or more spacer molecules to define a columnar structure. FIG. 3 illustrates such an embodiment wherein the columnar spacers 120 are formed from three molecular species bound to a single particle 130, such that a plurality of particles 130 forms a dense array 135. It should be appreciated that depending on the relative diameter of the particle to the spacer it may be preferable to bond more or less than three molecular spacers to a single particle. A suitable particle or nanoparticles 130 for forming the array 135 of FIG. 3 may contain three reactive sites, or a single reactive site may be extended with a tetra-functional monomer to produce three remaining bonding sites. It should be appreciated that using three molecular species 120a, 120b and 120c to bond particle 130 will result in the column that will be effectively stiffer than if it where derived from just a single molecule, as bending requires the cooperative motion of the three molecules.

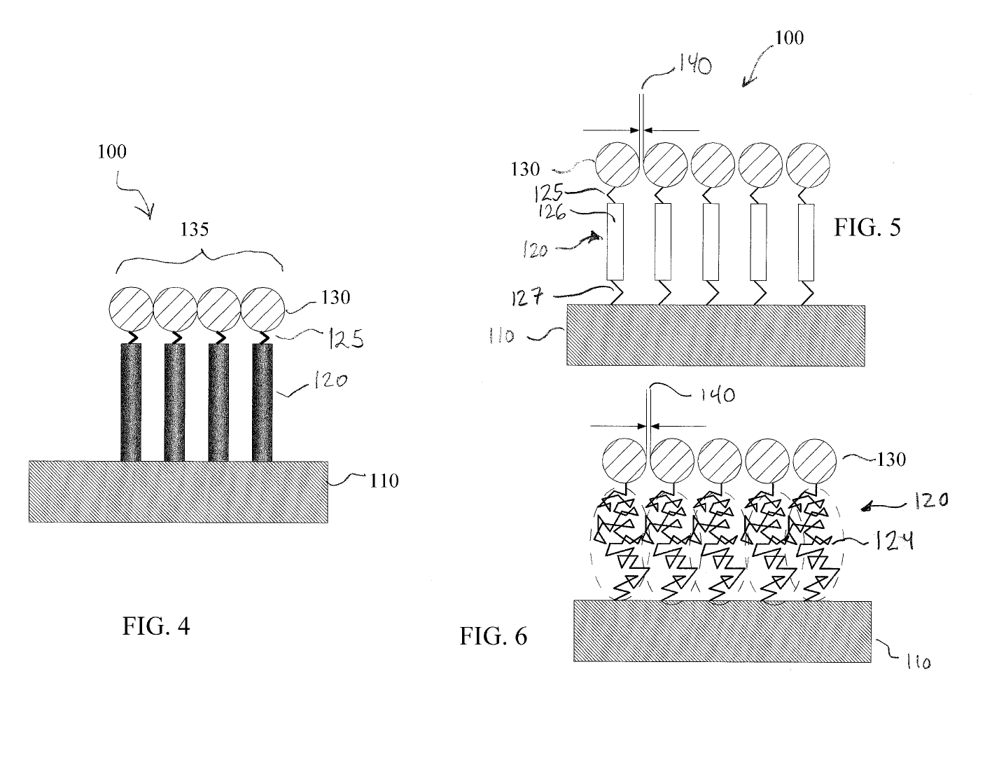

FIG. 4 illustrates an embodiment wherein the columnar spacers 120 are non-conductive nanotubes, In a preferred embodiment, the carbon nanotubes are functionalized with a relatively short spacer ligand 125 to bond the nanoparticles to the upper surface of the nanotubes described in U.S. Pat. No. 6,458,327, which is incorporated herein by reference. Although nanotubes could also be chemically bound to a substrate surface by similar methods,

FIG. 5 illustrates an embodiment wherein the columnar spacers 120 include a mesogenic segment or part of a molecule or macromolecule having sufficient anisotropy in both attractive and repulsive forces to form an ordered or liquid crystal phase. The mesogenic portion 126 of the molecule that forms the column is bonded at the lower end to the substrate via a ligand 127 and at the other end to the gold particles, preferably via a relatively short spacer ligand 125.

FIG. 6 illustrates an embodiment wherein the columnar spacers 120 are alternatively a lipid, lipid bilayer, phospholipid, protein or other biologically derived or analogous macromolecule. In this schematic illustration, such a biologically derived or analogous macromolecule 124 retains a definite shape to form columnar spacer 120 being attached to the substrate 110 at one end and to the nanoparticles 130 at the other end. The preferred size of the attached particle would vary with the size and aspect ratio of the macromolecule selected in order to form an array wherein the particles touch or are in close proximity.

Particularly preferred macromolecules for forming columnar spacer 124 are double stranded (ds) DNA and RNA. The column height is limited by the mean persistence length which is 56.4 nm for long DNA and 63.8±0.7 nm for dsRNA. First, single stranded (ss) DNA or RNA is covalently bound to the surface through tethers. The tether is comprised of the following components: a docking moiety, a spacer arm linked to a photolytic component and a bioconjugation component for covalent attachment of the DNA, RNA or another rigid biopolymer through specific sites on its surface. A photolytic signal induces cleavage within the tether with the dock releasing the bioconjugate, with the linker parts only remaining attached to the surface. Eventually, the surface of the substrate surface will be structured into a high density array of biopolymer columns with ends that are highly reactive towards the capping molecules of metallic nanoparticles. Since desorption is usually performed after the bioconjugation step the photolytic site must remain photoactive after covalent conjugation. The dsDNA column is prepared by covalently linking a single strand with an amino modified 5′ end to the tethered surface and then hybridizing it with a complementary stand, carrying the metallic nano dot on its 5′ end. Such methods are well known to one of ordinary skill in the art, as exemplified by the disclosures of Herne, T. M. and Tarlov, M. J. in J. Am. Chem. Soc, 119, 8916-8920 (1997) which is also incorporated herein by reference. Hence, the adaptation to enable the invention now disclosed herein need not require undue experimentation. Further, the hybridization is done under stringent conditions, that is near the Tm, at high ionic strength (1M), kosmotrophic ions (Na+). The incoming hybridizing DNA would carry a gold quantum dot (Au—NP) attached to its 5′ end through a thiolated end group or amino group which reacts with a NHS group carried by the gold or other metallic nanoparticle.

An extremely efficient light dependent triggering device for the release of tethered biomolecules is used. Poly(N-ethylamine-4-vynilpyridinum) is a nonconjugated hydrophobic polymer that presents a pyridyl nitrogen in a configuration such that upon aminoalkylation will provide a homogeneous class of photolytic bonds, and provides the chemical basis for extending outward with a photo resistant spacer arm. While the arm links to the photolytic site by an (—N-ethylsuccinamyl-) group it reacts with (N-hydroxysulfosuccinimide) to achieve covalent attachment to the biopolymer end. Desorption is usually achieved with a standard UV laser such as in a matrix-assisted laser desorption/ionization mass spectroscopy (MALDI-MS) that employs a UV laser (337 nm) also known in the art as Surface—Enhanced—Photo labile-attachment and Release (SEPAR).

The desired spacing between the biomolecules that form the columns is achieved by the lithographic patterning to selectively remove excess biomolecules. To achieve a resolution of a few nanometers, an interference photolithography is preferably employed. The laser induced desorption Procedure is more fully disclosed by Hutchens, T. W., and Yip, T. T. (1994). International Patent (PCT) Publication No. WO94/28418 (now U.S. Pat. No. 7,071,003, issued Jul. 4, 2006), Hutchens, T. W., Ching, J., and Yip, T. T. (1995). Protein Sci. 4 (Suppl. 2), 99 (Abstract 204-S) Ching, J., Voivodov, K. I., and Hutchens, T. W. (1996). J. Org. Chem. 61, 3582-3583. Voivodov, K. I., Ching, J., and Hutchens, T. W. (1996) Tetrahedron Lett. 37, 5669-5672. Jesus Ching, Kamen I. Voivodov, and T. William Hutchens, (1996), Bioconjugate Chemistry, 7///—(5),1996-2000, all of which are incorporated herein by reference.

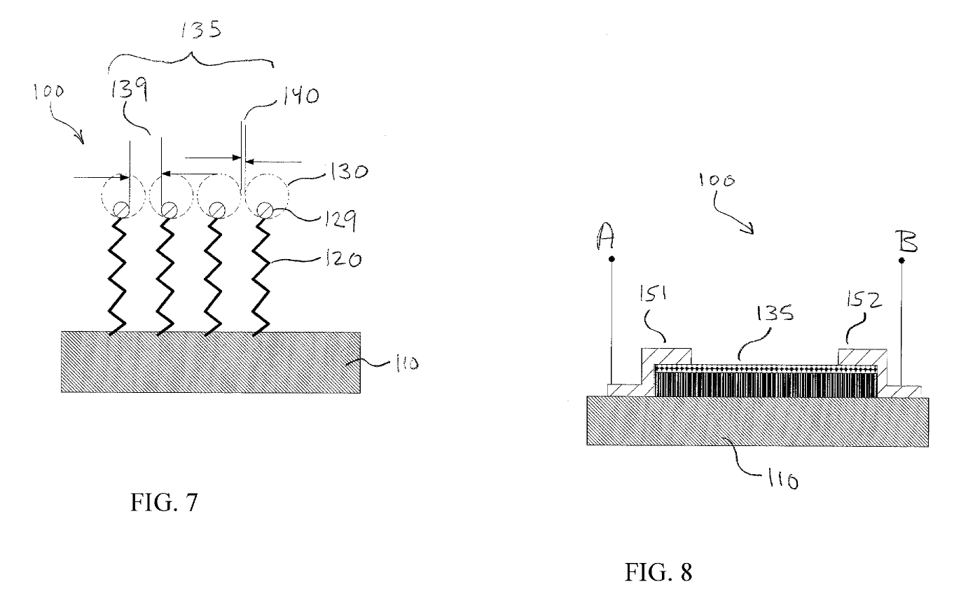

FIG. 7 illustrates an embodiment of the invention wherein initially a smaller particle 129 is attached to the molecular structure or other assembly that constitutes column 120 on substrate 110. The initial spacing between these particles 139 is comparable to the spacing between columns 120. However as the particles are grown to the size reflected by the dashed line 130, the inter-particle spacing 140 is now reduced such that deformation or impact to the substrate 110 will be reflected in the movement of one or more of columns 120 such that a measurable perturbation occurs in the array 135 of the larger particle 130. For examples, nanoparticles 129 of an initial diameter of about 1.4 nm is preferably grown to a 15-20 nm diameter nanoparticle 130 after attachment to the molecular species that form the columns 120.

As gold nanoparticles functionalized with a single reactive group are commercially available, they can be readily attached to any of the columnar species described herein having a co-reactive complimentary group on the outer surface. For example, Mono-Sulfo-NHS-“NANOGOLD”™ is a 1.4 nm gold nanoparticle with a single reactive group, a sulfo-N-hydroxysuccinimide ester (sulfo-NHS) that reacts with primary amines under mild conditions (circa pH 7.5 to 8.2) (Available from Nanoprobes, Incorporated: 95 Horse Block Road, Yaphank, N.Y. 11980-9710, USA). An array of Mono-Sulfo-NHS-“NANOGOLD”™ particles are readily attached to any amine terminated columnar spacer by incubation of the substrate with the Mono-Sulfo-NHS-“NANOGOLD”™ for 2 hours at room temperature. The substrate is then washed and dried to remove excess “NANOGOLD”™ reagent.

When the initially deposited nanoparticles have a diameter substantially less than the diameter of the columnar molecule that acts as a spacer, it is desirable in an additional step to grow the nanoparticles of gold. It is also desirable to grow or enlarge the as deposited nanoparticles when the columnar molecules have a spacing that is substantially larger than the nanoparticles diameter. Such method are well known in the field of histology, wherein various reagents are commercially available to cover nanospheres of gold with silver, gold or silver followed by a thin gold coating. For example the “GoldEnhance”™ reagent kit is also available from Nanoprobes for this purpose. Alternatively, nanoparticles of gold can be expanded by incubation at room temperature on an aqueous solution of 0.5 mM HAuCl₄ and 0.5 mM NH₂OH for about 2 minutes. The substrate is then washed with water and blown dry with Nitrogen or another inert gas.

The gold particles are grown to the desired size by simply extending the incubation period in the Gold Enhance reagent for as long as is desired. Although it is possible to use repeated electrical continuity measurements to determine when the conductive particles have grown to the point at which they touch, a preferred method utilizes the change in color from blue, for the original NANOGOLD™ particles, to red as the particles grow to a size where they touch, or are close enough and no longer interest with incident light as quantum dots. The change in color occurs because the surface plasmon resonance absorption of discrete gold nanoparticles red shifts with a broader spectral shapes from the initial spectral placement (centered at roughly 545 nanometers) as the particles move farther apart. Accordingly, in the more preferred embodiments it is preferable that the substrate 110, or the combination of substrate and spacer, are somewhat reflective so this red shift can be observed visually or measured in reflection from the substrate to terminate the growth of the nanoparticles of gold. In the case of this example, it was preferable to grow the gold-nanoparticles to a diameter of about 20 nm. However, in other embodiments depending on the width, length, binding density and flexibility of the molecular species that constitutes of column 120 a different range of final particle size might be preferred. As a generally preferred range of the size of particle 120 is up to 20 nm.

In another embodiment of the invention, FIG. 8 illustrates a full sensor device 100 that now includes electrodes 151 and 152 contacting opposing sides of the nanoparticle array 135 and extending to cover adjacent portions of the same side of substrate 110. Thus, the electrical resistance is measured between terminals A and B is used to determine if substrate 110 has been perturbed in a manner that affects the electrical continuity through array 135. It should be appreciated that the coating on substrate 110 may include any of the species described with respect to FIG. 1 through 8.

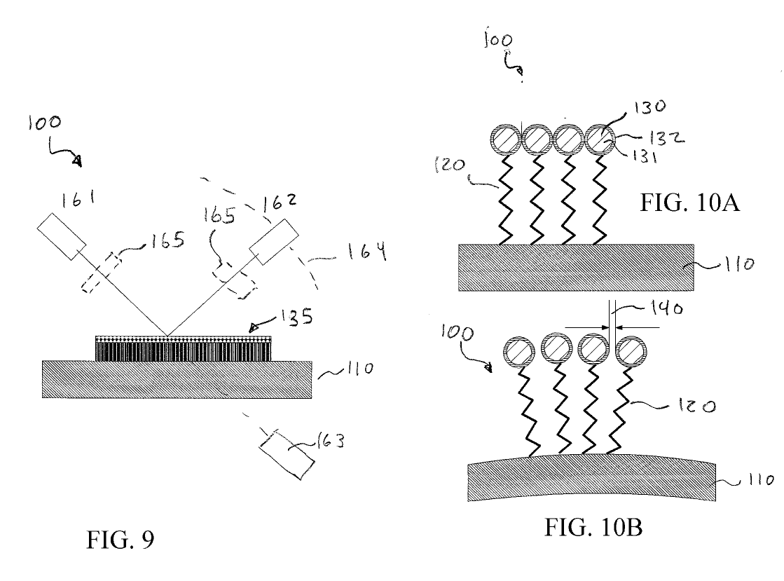

In another embodiment of the invention, FIG. 9 illustrate a sensor 100 that now includes a photodetector 162. The photodetector 162 preferably is a multichannel type capable of simultaneous measuring multiple wavelengths to detect spectral shifts in the emissive, absorptive or reflective properties of array 135 arising from a perturbation initiated by impact or deformation of substrate 110. The device 100 optionally includes a photoemitter 161 when ambient light is not being either present or inadequate to generate a signal capable of measurement by photodetector 162. Alternatively, as perturbation in the structure of array 135 may also give rise to a unique diffraction pattern (if the wavelength of light is comparible with the size of the particle), photoemitter 161 optionally produces a collimated beam of incident radiation and photodetector 162 is capable of movement in arc 164 to measure the angular dispersion of scattered or diffracted radiation by array 135. Alternatively, a different photodector 163 may be placed on the reverses side of substrate 110 from photoemitter 161 to measure the change in absorption spectra of array 135.

To the extent that the perturbation in array 135 is measured optically, that is by the change in transmission, reflection or absorption spectral or diffraction patterns, the nanoparticles are not necessarily conductive. Alternative nanoparticles for this purpose may include particle and nanoparticles that comprise wide band gap semiconductors, such as CdS, CdSe, ZnS, CdTe, ZnSe or other molecular-sized semiconductor crystals nanocrystals that are highly fluorescent at a characteristic wavelength that would undergo a change or shift with the interparticle spacing. For example, particles include nanocrystals and quantum dots that absorb light and then re-emit the light in a different wavelength depending on the state of aggregation, medium or contact, the method of optical detection may include florescence measurement. It is well known that the size of the nanocrystal determines the color. For example, the peak fluorescence wavelength of highly crystalline CdSe of 25 nm particle size is tunable with a 2-10 nm change in diameter.

It should also be appreciated that when optical measurements alone are deployed to characterize or detect the perturbation in particle array 135, the columns 120 that space the particle 120 from substrate 110 need not be non-conductive.

The device in FIG. 9 may also include optical filters 165 to absorb or block characteristic wavelengths, as for example fluorescence wavelength, such that photodetector 162 need not perform wavelength discrimination. Alternatively, optical filter 165 may be an agile variable filter or wavelength scanning device to provide wavelength discrimination to photodetector 162.

In alternative embodiments the optical filtering component need not be a discrete component, but can be is coated or chemisorbed on the particles. This is schematically in FIG. 10A, wherein particles 130 have a core 131 coated with an absorbing layer 132. Although the particles 130 do not initially touch to completely block light, layer 132 fill the molecular scale gap between them. Thus, depending on the absorption characteristic of coating 132, specific wavelengths of light would be blocked from transmission between opposite sides of substrate 110. However, as the particles 130 move apart in FIG. 10B in response to deformation of substrate 110 a gap 140 opens between the outer layers of coating allowing light to pass through. One such example of an absorbing coating layer 132 is carbon monoxide to block IR light.

It should be appreciated that alternative ways of depositing the columnar spacers includes Non-conductive columnar spacer is produced by self-assembled monolayer (SAM) bonded to the substrate, such a SAM consists substantially of —(—CH2-)-, liquid crystal molecules. Further details on these and other methods of binding micro and nano sized metallic particles to substrates are disclosed in U.S. Pat. No. 6,242,264 (to Natan, et al., issued Jun. 5, 2001 for “Self-assembled metal colloid monolayers having size and density gradients”), which is incorporated herein by reference. In alternative embodiments, the particle or preferred nanoparticles need not be covalently bound to the column. For example, nanoparticles may also be attached to the non-conductive spacer by ionic bonding. For example, an amine group on the top of the column and a citrate functionalized nanoparticle. Alternatively, depending on the threshold of force measurement desired, it is possible to use larger particles and/or form the columnar structure by lithographically etching or molding a spacer having micro or possibly nano-dimensions. In such cases, it is possible that the substrate and spacer layer, the collection of columns 120 are formed out of a single monolith, rather than a layered material.

Such lithographic fabrication methods are now described with respect to the following theoretical examples of representative processes, in which it will be appreciated that the desired size and shape of the columns dictates the fabrication process. Nano size columns generally re conventional photolithography and mandate using E-Beam lithography.

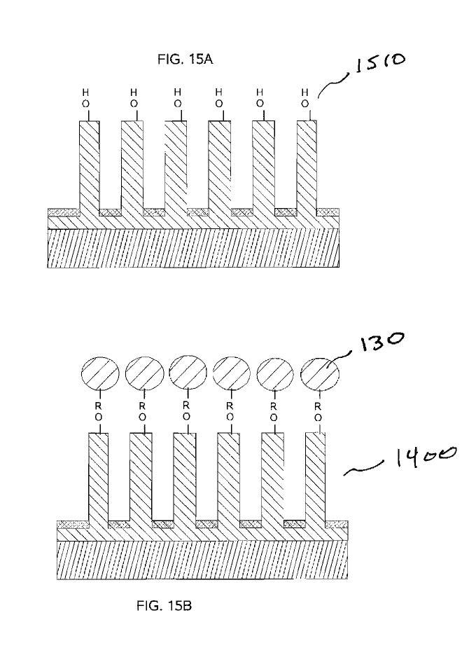

It is generally preferred that columns should have a high aspect ratio, that is preferably at least about of around 100:1. Such a high aspect ratio can be fabricated using deep reactive ion etching (DRIE) with a modified Bosch process in both processes. E-Beam lithography or Photolithography is used to image a mask in a first photoresist on the portion of a silicon or silicon oxide substrate to be etched by DRIE. The columns are then cast of a second photoresist resin into the deep cavities etched into this substrate. In this second step the columns are preferably made out of SU-8, which is itself an epoxy resin based negative photoresist. SU-8 It has a high bi-axial modulus of elasticity (˜5 GPa) as reported by H. Lorentz”, J. Micromech. Microeng 7: 121-124 (1997) and H. Lorenz, et al. in Microsyst. Technol. 4: 143-146, (1998). SU-8 also has a Low Poisson ratio (0.22), its relative dielectric constant (∈ᵣ₎) is 4.5 at 10 MHz with a very high breakdown voltage (>10⁷ V/M). It has very low optical absorbency in the near UV part of the spectrum (365 nm) allowing the photoresist to be cured to a depth of 2 mm. The photoresist is cast by spinning into a negative mask made out of silicon. A flexible surface made out of PDMS to be cast on the SU-8 back. (FIG. 14A). SU-8 is available from MicroChem Corp. (MCC) located in Newton, Mass. The metallic pads should be deposited using the focused ion beam induce deposition method (FIBID).

The metallic nanoparticles are self assembled and covalently attached to the modified tops of the columns and linked to the electrode pads. The fabrication of dielectric columns (e.g. 50 nm by 700 nm) necessitates the creation of a negative silicon mask with a pattern of cylindrical cavities of the required dimensions. The mask fabrication is shown in FIG. 11A-13A, with the final mold shown in FIG. 14A.

This is achieved by using E-Beam lithography and anisotropic etching of a crystalline S(100) wafer using the methods generally disclosed by Xia, Y and Whitesides, G. M. in Adv. Mater, 8:765-768 (1996) as well as that by Kim, E. et al. in, J. Electrochem. Soc, 142:628-633 (1995), both of which are incorporated herein by reference.

Even though fabrication of small structures on micro/nano-scale ranges is enabled by electron-beam lithography, for the manufacturing of large-area nano-scale patterns its throughput is too low since it requires sophisticated and expensive instrumentation as further described by Ross, C. A. et al. in J. Appl. Phys. 2002, 91, 6848, which is incorporated herein by reference. However, interferometric lithography (IL) is a very promising, low-cost, reliable, and scalable technology for the fabrication of nano-scale periodic patterns over large areas. For UV Interference lithography, two (or a few) coherent UV beams are used to produce a periodic interference pattern with the spatial period P=λ/2 sin φ, where λ is the wavelength and φ is the half angle between the two beams with the addition of immersion techniques, as disclosed by Raub, A. K. and Brueck, S. R. in J. Proc. SPIE, 5040, 667 (2003), which is incorporated herein by reference. The limits of interferometric lithography extend to periods of λ/2n, where n is the immersion liquid refractive index. Therefore, Interferometric lithography is capable of periods of ≦75 nm (λ/2n for λ=193 nm and n(H2O)) 1.44) and spaces of 35 nm as taught for example by D. Xie and S. Brueck in, Nano. Letters, 4 (7), 1295-1299, (2004), which is incorporated herein by reference. Extreme ultraviolet interference lithography (EUV-IL) is capable of producing 20 nm resolution as taught by Gronheid, R. et al. in Microelectr. Eng, 83, 1103-1106 (2006), which is incorporated herein by reference.

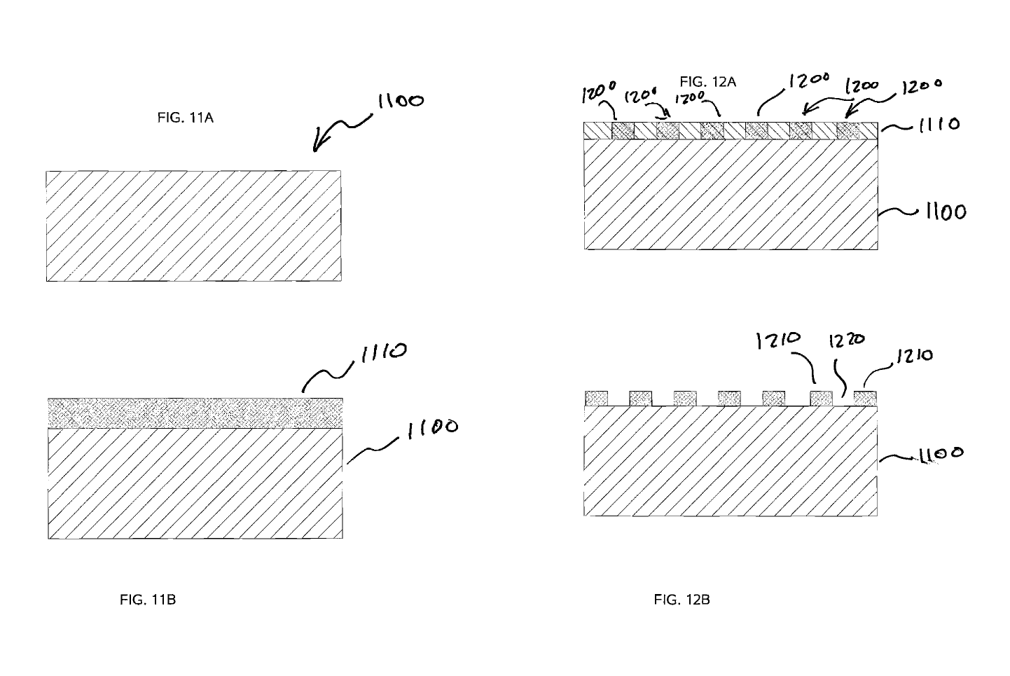

Thus, in the first step of the process a silicon or silicon on insulator (SOI) wafer (1100 in FIG. 11A) with a 0.7 μm Si(100) device layer on an SiO₂ is coated with poly(methyl methacrylate (PMMA) dissolved (3%) in Anisole safe solvent. The polymer is spread evenly (a speed of 1000-5000 rpm, 60′, 1800C hotplate, and 90″), forming the resist layer 1110 in FIG. 11B. An array of 50 by 50 nm squares 1200 (in FIG. 12A) is patterned by the E-Beam (line dose<1 nC/cm), developed with 1:3 MIBK:IPA, 70″, rinsed with IPA and dried with N₂, resulting in masked portions 1210 in FIG. 12B, and exposed portions of silicon or silicon oxide 1220 between the remaining portion of the PMMA layer 1110.

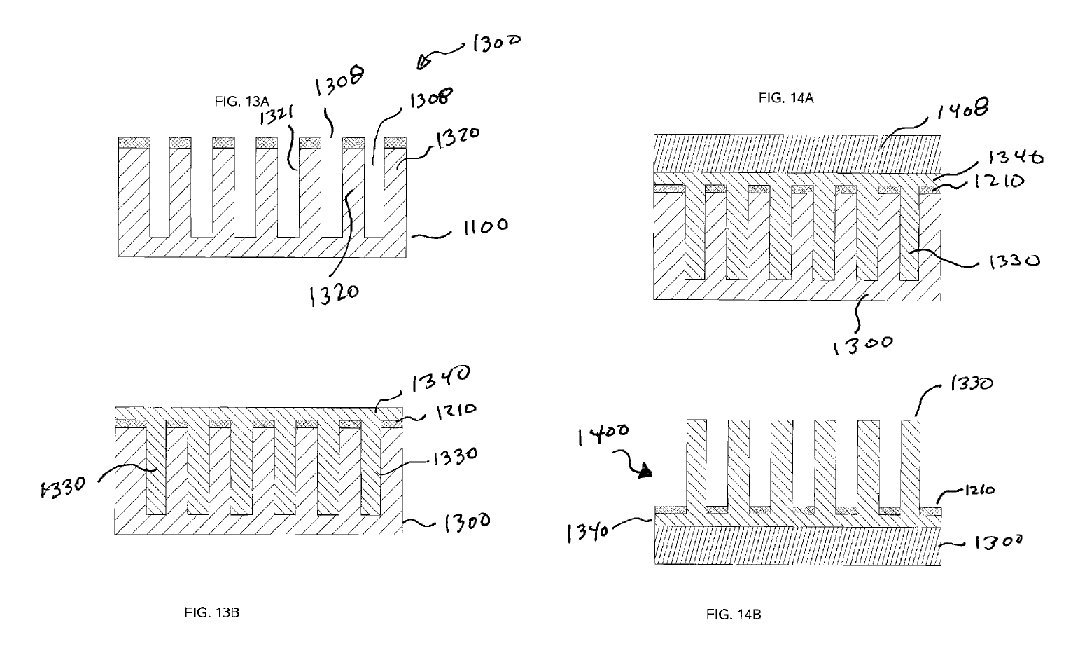

In the next step, anisoitropical etching is done by deep reactive ion etching (DRIE/ICP) with SF₆+0₂ with the rate of 0.5-1 μm/min resulting in the silicon mask or mold 1300, as shown in FIG. 13A. the mask or mold 1300 has deep bores 1308 in the silicon 1100 formed between tall columns 1320. The reaction of fluorine provides maximal passivation of the walls 1321 of columns 1320 so that stiction between SU-8 columns and the silicon mask 1300 will be prevented. The SU-8 or other resist precursor solution is applied to the surface of mask 1300 (typically at about 1 ml per 1 inch of diameter) and spread for 5″ at 500 rpm and spun (3000 rpm for 30″), then first soft baked at 65° C. for 60 minutes before the final cure at 95° C. for 3 minutes). The SU-8 is cured with exposure is in the N-UV i-line (350-400 nm) with exposure energy of ˜50-100 mJ/cm². Preferably an optical filter is used to cut out a wavelength of less than 350 nm. The resulting columns 1330 of SU-8 preferably have a near perfect ˜89° profile, as shown in FIG. 13B, the columns are preferably connected by a continuous base 1340 of cured SU-8.

Next, as shown in FIG. 14 an elastomer layer 1408, preferably PDMS is deposited after the SU-8 is cast and is supposed to cover the remaining PMMA 1210 and SU-8 1340. Curing is performed with the SU-8 with exposure in the N-UV i-line (350-400 nm). When using PDMS, care must be taken that the material is not introduced to the KOH solution. PDMS has a number of useful properties in that it is resistant towards most materials, has low surface free energy (γ=21.6 dyne/cm²), optically transparent down to 300 nm and thermally stable (˜150° C.), is physically tough (4.77 MPa) and is flexible (elastic modulus of 1.8 MPa, but when UV cured has a modulus of about 4 MPa, and when thermally cured has a modulus of 8.2 MPa and elongation up to 160%, as disclosed generally by Gates, B. et al. in the Annu. Rev. Mater. Res, 34:339-372 (2004), which is incorporate herein by reference.

In the next step, etching of the silicon 1300 is done in a solution of 5.9 N KOH at 95° C. The wafer is rotated at ½-⅓ rev/sec to insure the uniformity of temperature. This was followed by DI water dipping in 50:1 HF solution to remove any silicon dioxide residuals and then rinsed again in DI water to remove HF residuals, as is generally disclosed by the teachings of Vu, Q. B. et al in the J. Electrochem. Soc, 143(4), 1372-1375(1996), which is incorporate herein by reference (FIG. 14B). This leaves the basic columnar structure 1400 having the PDMS layer 1408 as the base.

In the next step gold electrode are deposited on two opposing sides of the nanoparticle array. Direct deposition of gold electrodes on two opposing vertices, without the need for a resist layer can be accomplished by using focused ion beam induced deposition (FIBD) in which the precursor molecule in its volatile state (e.g. dimethyl-gold-acetylacetonate) introduced into a vacuum environment in the vicinity of the substrate for deposition. Primary electrons and secondary ones emitted by the substrate dissociate the precursor molecule and the metal is deposited on the surface, such processes and methods are more completely disclosed by Botman, A. et al. in Nanotechnology, 17, 3779-3785(2006) as well as by Lipp, et al. in, Microelectron. Reliab, 36 (11,12), 1779-1782(1996), both of which are incorporate herein by reference. For example, using a FEINova 600 Dual Beam system the deposition can be expected to be performed using a beam of 20 Kv and beam current of 620 pA and a probe size of ˜10 nm to achieve a deposition rate of about 30 nm/min. Energy dispersive energy analysis (EDX) can be used to verify the thickness of the deposited gold electrodes.

Prior to the deposition of gold or other metallic nanoparticle 130 or quantum dots the SU-8 1330 or other photoresist surface is activated for chemical attachment by a surface modification. In the case of the SU-8 epoxy groups are opened to hydroxyl (—OH) 1510 groups as shown in FIG. 15A by treatment with KOH. The surface —OH groups are activated with a suitable reactive group (—R), for example N,N′-Disuccinimidylcarbonate (DSC) under of conditions of about 0.3 mM in 50:50 dry acetone: dry pyridine, with 54 mmole anhydrous triethylamine under incubatation for about 1 hr at room temperature. The device is then washed with acetone and isopropanol, followed by continue washing with double distilled water as described by Wilcheck, M. and Miron, T, in Appl Biochem, Biotech, 11,191(1985)

Gold nanoparticles 130 capped with primary amino groups can then be coupled to the modified surface as shown in FIG. 15B. This can be done under conditions of a 10-fold molar excess of the ligand in an aqueous buffer (0.1M MOPS (pH 7.0), 0.1-0.2 M Phosphate buffer (pH 7.5, but without primary amine) which can be expected to yield coupling with efficiencies exceeding 80%. After coupling the resulting device should be rinsed with the coupling buffer and incubate with 1M ethanolamine (for 10 min) and washed again.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A sensor comprising:
a) non-rigid substrate,
b) a columnar spacer disposed on said non-rigid substrate,
c) an array of particles bonded to said substrate via said spacer wherein at least one column is connected to each particle,
d) whereby deformation of said non-rigid substrates results in a perturbation to the distribution of the particles in said array to produce a measurable change in an aggregate physical property of said array.

2. A sensor according to claim 1 wherein the physical property is at least one of electrical resistance, optical transmission, wavelength selective absorption of light and a diffraction pattern.

3. A sensor according to claim 1 wherein the particles are nanoparticles.

4. A sensor according to claim 3 wherein the nanoparticle are conductive and the columnar spacer is non-conductive.

5. A sensor according to claim 3 wherein the nanoparticles are selected from the group consisting of Au, Ag, Pt, Pd, Ni(B) or Ni(Ph), ITO, SnO2 and the columnar spacer is non-conductive.

6. A sensor according to claim 3 wherein the particles are gold nanoparticles.

7. A sensor according to claim 3 wherein the non-conductive columnar spacer has a height that is at least about two times the diameter of the nanoparticles.

8. A sensor according to claim 4 wherein the non-conductive columnar spacer has a height that is at least about two times the diameter of the nanoparticles.

9. A sensor according to claim 3 wherein the columnar spacer is selected from the group consisting of a lipid, lipid bilayer, phospholipid, protein, biologically derived and an analogous macromolecule.

10. A sensor according to claim 3 wherein the non-conductive columnar spacer is a double stranded nucleic acid.

11. A sensor according to claim 1 where the measured phenomenon is thermal expansion or contraction of the substrate.

12. A sensor according to claim 15 where the substrate is made out of two different materials with different thermal expansion coefficients.

13. A process for forming a sensor, the process comprising the steps of:
a) providing a substrate,
b) forming a columnar support structure on the substrate,
c) bonding particles to the support structure.

14. A process for forming a sensor according to claim 13 wherein said bond step occurs before said step of providing a substrate.

15. A process for forming a sensor according to claim 13 wherein at least one of said step of forming a columnar support structure and bonding particles to the support structure comprises the formation of a self-assembling monolayer.

16. A process for forming a sensor according to claim 13 wherein particles are nano-particles or quantum dots.

17. A process for forming a sensor according to claim 13 wherein the columnar support structure has a height that is at least twice the diameter of the nano-particles.

18. A process for forming a sensor according to claim 13 further comprising growing the nano-particle size after said step of bonding to the columnar support structure on the substrate.
